(19) United States
(12) Patent Application Publication
(10) Pub. No.: US 2025/0290939 A1
(43) Pub. Date: Sep. 18, 2025

(54) AUTOMATED TESTING SYSTEM

(71) Applicant: Quanta Computer Inc., Taoyuan City (TW)

(72) Inventors: Hsien-Chang TSAI, Taoyuan City (TW); Fu-Shiang CHANG, Taoyuan City (TW); Chien-Chung LAI, Taoyuan City (TW); Te-Li CHEN, Taoyuan City (TW)

(21) Appl. No.: 18/748,497

(22) Filed: Jun. 20, 2024

(30) Foreign Application Priority Data
Mar. 12, 2024 (TW) 113108975

(51) Int. Cl. G01N 35/00

(52) U.S. Cl. CPC G01N 35/00693; G01N 2035/00346

(57) ABSTRACT

An automated testing system includes a server device, a first testing device and first laboratory equipment. The server device includes a storage unit, and the storage unit stores laboratory equipment data. The first testing device sets a first testing parameter, reads the laboratory equipment data, generates a first control command to the server device according to the first testing parameter and the laboratory equipment data, tests a first device under test according to the first testing parameter to generate a first testing result, and stores the first testing result in the storage unit. The first device under test is placed in the first laboratory equipment. The server device controls the operation of the first laboratory equipment according to the first control command, and the server device reads the first operating state of the first laboratory equipment and stores the first operating state in the storage unit.

### CROSS REFERENCE TO RELATED APPLICATIONS

This application claims priority of Taiwan Patent Application No. 113108975, filed on Mar. 12, 2024, the entirety of which is incorporated by reference herein.

### BACKGROUND OF THE INVENTION

### Field of the Invention

The present invention relates to a testing system, and in particular it relates to an automated testing system.

### Description of the Related Art

In general, after an electronic element is manufactured, the electronic element may be tested by a testing system to determine the state of the electronic element.

However, the above testing system may include laboratory equipment and a testing station, the parameters of the above laboratory equipment and the above testing station respectively need to be manually set by the user, and the testing results of the laboratory equipment and the testing station may also need to be manually obtained and compiled, respectively, by the user. This may increase the error rate of the parameter setting, increase the testing time and the testing cost, and decrease the convenience of use. Therefore, how to effectively decrease the error rate of the parameter setting, decrease the testing time and the testing cost, and increase the convenience of use has become a focus for technical improvements by various manufacturers.

### BRIEF SUMMARY OF THE INVENTION

An embodiment of the present invention provides an automated testing system, thereby effectively decreasing the error rate of the parameter setting, decreasing the testing time and the testing cost, and increasing the convenience of use.

An embodiment of the present invention provides an automated testing system, which includes a server device, a first testing device and first laboratory equipment. The server device includes a storage unit. The storage unit is configured to store laboratory equipment data. The first testing device is connected to the server device. The first testing device is configured to set a first testing parameter, read the laboratory equipment data, generate a first control command to the server device according to the first testing parameter and the laboratory equipment data, test a first device under test according to the first testing parameter to generate a first testing result, and store the first testing result in the storage unit. The first laboratory equipment is connected to the server device. The first device under test is placed in the first laboratory equipment. The server device is configured to control the operation of the first laboratory equipment according to the first control command. The server device is configured to read the first operating state of the first laboratory equipment and store the first operating state in the storage unit.

According to the automated testing system disclosed by the present invention, the first testing device sets the first testing parameter, reads the laboratory equipment data the storage unit of the server device, generates the first control command to the server device according to the first testing parameter and the laboratory equipment data, tests the first device under test placed in the first laboratory equipment according to the first testing parameter to generate the first testing result, and stores the first testing result in the storage unit. In addition, the server device controls the operation of the first laboratory equipment according to the first control command, and the server device reads the first operating state of the first laboratory equipment and stores the first operating state in the storage unit. Therefore, it may effectively decrease the error rate of the parameter setting, decrease the testing time and the testing cost, and increase the convenience of use.

### BRIEF DESCRIPTION OF THE DRAWINGS

The present invention can be more fully understood by reading the subsequent detailed description and examples with references made to the accompanying drawings, wherein:

FIG. 1 is a schematic view of an automated testing system according to an embodiment of the present invention; and

FIG. 2 is a schematic view of an operation of an automated testing system according to another embodiment of the present invention.

### DETAILED DESCRIPTION OF THE INVENTION

In each of the following embodiments, the same reference number represents an element or component that is the same or similar.

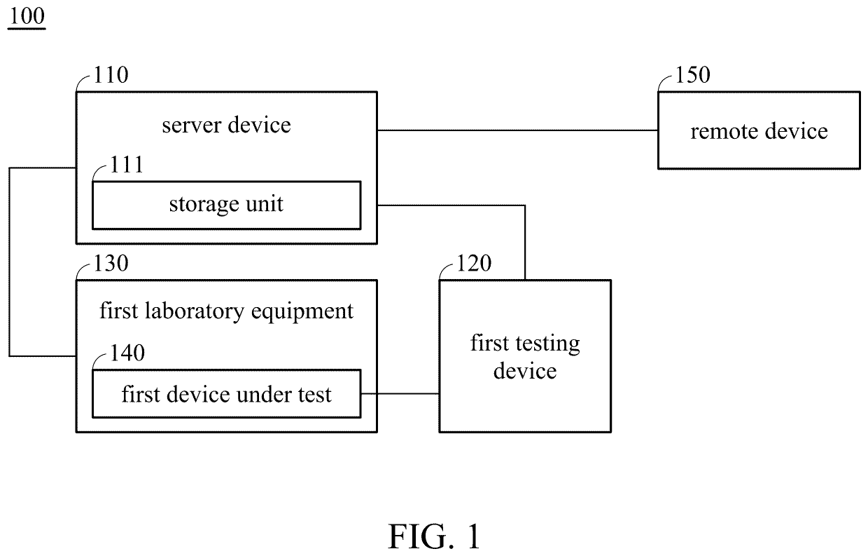

FIG. 1 is a schematic view of an automated testing system according to an embodiment of the present invention. Please refer to FIG. 1. The automated testing system 100 may include a server device 110, a first testing device 120 and first laboratory equipment 130.

The server device 110 may include a storage unit 111. The storage unit 111 stores laboratory equipment data. In the embodiment, the storage unit 111 may be a hard disk, a solid state disk, a memory, etc., but the embodiment of the present invention is not limited thereto.

The first testing device 120 may be connected to the server device 110. In the embodiment, the first testing device 120 may be connected to the server device 110 through wired network equipment or wireless network equipment. For example, the wired network equipment may include a wired network switch and a network line, and may perform the data receiving or the data transmission through Ethernet, optical fiber network, asymmetric digital subscriber line (ADSL), etc.

In addition, the wireless network equipment may include a wireless network switch and a wireless network access point (AP), and may use, for example, wireless fidelity (WiFi) technology, or other telecommunication network technologies to perform the data receiving or the data transmission.

The first testing device 120 may set a first testing parameter. That is, the user may operate the first testing device 120 to set the first testing parameter. In the embodiment, the first testing parameter may include a testing parameter required for testing a first device under test 140 and a control parameter of the first laboratory equipment 130.

The first testing device 120 may read the laboratory equipment data. That is, the first testing device 120 may access the storage unit 111 of the server device 110 to read the laboratory equipment data stored in the storage unit 111. In some embodiments, the laboratory equipment data may include the related data of the first laboratory equipment 130, such as the first laboratory equipment 130 being in a normal state, an abnormal state, etc.

The first testing device 120 may generate a first control command to the server device 110 according to the first testing parameter and the laboratory equipment data. That is, the first testing device 120 may generate the first control command to the server device 110 according to the control parameter of the first laboratory equipment 130 in the first testing parameter and the laboratory equipment data.

In some embodiments, the first control command may include a function code, an equipment identifier (equipment ID) and control data, but the embodiment of the present invention is not limited thereto. In addition, the above function code includes, for example, a writing code or a reading code. Furthermore, the above equipment identifier is, for example, an equipment identifier of the first laboratory equipment 130. Moreover, the above control data includes, for example, temperature, humidity, etc.

The first testing device 120 may test the first device under test 140 according to the first testing parameter to generate a first testing result. That is, the first testing device 120 may test the first device under test 140 according to the testing parameter required for testing the first device under test 140 in the first testing parameter to generate the corresponding first testing result. In addition, the first testing device 120 may transmit the first testing result to the server device 110 and store the first testing result in the storage unit 111. Furthermore, the first testing device 120 may also display the first testing result.

The first laboratory equipment 130 may be connected to the server device 110. In addition, the first device under test 140 may be placed in the first laboratory equipment 130. In the embodiment, the first laboratory equipment 130 may be connected to the server device 110 through the wired network equipment or the wireless network equipment. For example, the wired network equipment may include the wired network switch and the network line, and may perform the data receiving or the data transmission through Ethernet, optical fiber network, asymmetric digital subscriber line, etc. In addition, the wireless network equipment may include the wireless network switch and the wireless network access point, and may use, for example, wireless fidelity technology, or other telecommunication network technologies to perform the data receiving or the data transmission.

In addition, the server device 110 may receive the first control command generated by the first testing device 120, and control the operation of the first laboratory equipment 130 according to the first control command. Then, the server device 110 may read the first operating state of the first laboratory equipment 130, and store the first operating state in the storage unit 111. Therefore, it may effectively decrease the error rate of the parameter setting and decrease the testing time and the testing cost.

In some embodiments the first testing device 120 is, for example, an auto test system (ATS) testing station, and the first testing device 120 may include a computer device and at least one testing element. The computer device may be connected to the first device under test 140 and the server device 110. The at least one testing element may be connected to the computer device and the first device under test 140.

In some embodiments, the above at least one testing element may include a chiller and a power supply, but the embodiment of the present invention is not limited thereto. Furthermore, the power supply may include a high voltage power supply or a low voltage power supply. Moreover, the user may select the number of testing elements in the first testing device 120 according to the requirements thereof.

In some embodiments, the first laboratory equipment 130 may include a temperature chamber, a chiller and a recorder. Furthermore, the first device under test 140 may be placed in temperature chamber of the first laboratory equipment 130. In addition, the above recorder may recode the temperature, humidity, etc. In the embodiment, the chiller in the first testing device 120 is different from the chiller in the first laboratory equipment 130.

The automated testing system 100 may further include a remote device 150. The remote device 150 may be connected to the server device 110. In the embodiment, the remote device 150 may be connected to the server device 110 through the wired network equipment or the wireless network equipment. In addition, the wireless network equipment may include the wireless network switch and the wireless network access point, and may use, for example, wireless fidelity technology, or other telecommunication network technologies to perform the data receiving or the data transmission.

The remote device 150 may access the server device 110 to read the laboratory equipment data, the first testing result and the first operating state from the storage unit 111, and display the laboratory equipment data, the first testing result and the first operating state. Therefore, the user may know the first testing result of the first testing device 120 and the first operating state of the first laboratory equipment 130 through the remote device 150, so as to increase the convenience of use.

In addition, the remote device 150 may further display the complete data or the partial data of the laboratory equipment data, the first testing result and the first operating state. The above complete data is, for example, the data of the laboratory equipment data, the first testing result and the first operating state during the entire testing process. The above partial data is, for example, the data of the laboratory equipment data, the first testing result and the first operating state during a certain testing period of the entire testing process. That is, the user may operate the remote device 150, so that the remote device 150 displays the complete data or the partial data. Therefore, the convenience of use may be increased.

In addition, the first testing device 120 may further set the first testing parameter through the remote device 150. That is, the user may operate the first testing device 120 through the remote device 150 to set the first testing parameter. Therefore, the convenience of use may be increased.

In the entire operation of the automated testing system 100, the first testing device 120 sets the first testing parameter (i.e., the testing parameter required for testing the first device under test 140 and the control parameter of the first laboratory equipment 130) or the first testing device 120 sets the first testing parameter through the remote device 150. Then, the first testing device 120 reads the laboratory equipment data of the storage unit 111 of the server device 110. Afterward, the first testing device 120 generates the first control command to the server device 110 according to the first testing parameter and the laboratory equipment data.

Then, the server device 110 receives the first testing command generated by the first testing device 120, and executes the first testing command to control the operation of the first laboratory equipment 130. Afterward, the first testing device 120 tests the first device under test 140 according to the first testing parameter to generate the first testing result. Then, the first testing device 120 transmits the first testing result to the server device 110 and stores the first testing result in the storage unit 111, and displays the first testing result.

In addition, the server device 110 reads the first operating state of the first laboratory equipment 130, and stores the first operating state in the storage unit 111. Therefore, it may effectively decrease the error rate of the parameter setting and decrease the testing time and the testing cost.

Then, the remote device 150 accesses the server device 110 to read the laboratory equipment data, the first testing result and the first operating state from the storage unit 111, and displays the laboratory equipment data, the first testing result and the first operating state. Therefore, the user may know the first testing result of the first testing device 120 and the first operating state of the first laboratory equipment 130 through the remote device 150, so as to increase the convenience of use.

In some embodiments, the server device 110 may further perform a calibration process on the first laboratory equipment 130. For example, the user may set the calibration date of first laboratory equipment 130 and set the testing temperature, the heating range and the cooling range of the first laboratory equipment 130 on the server device 110, and the calibration date, the testing temperature, the heating range and the cooling range may be stored in the storage unit 111. Then, the server device 110 may determine whether the current data matches the calibration data.

In some embodiments, when the server device 110 determines that the current data does not match the calibration data, the server device 110 may not perform the calibration process on the first laboratory equipment 130. When the server device 110 determines that the current data matches the calibration data, the server device 110 may read the testing temperature, the heating range and the cooling range from the storage unit 111, and start to perform the calibration process on the first laboratory equipment 130.

Then, the server device 110 may read the temperature of the first laboratory equipment 130 from the storage unit 111, calculate the heating time corresponding to the heating range and calculate the cooling time corresponding to the cooling range, and store the temperature, the heating time and the cooling time of the first laboratory equipment 130 in the storage unit 111.

Afterward, the remote device 150 may read the temperature, the heating time and the cooling time of the first laboratory equipment 130 stored in the storage unit 111, and display the temperature, the heating time and the cooling time of the first laboratory equipment 130. Therefore, the user may know the related data that the server device 110 calibrate the first laboratory equipment 130 through the remote device 150, so as to increase the convenience of use.

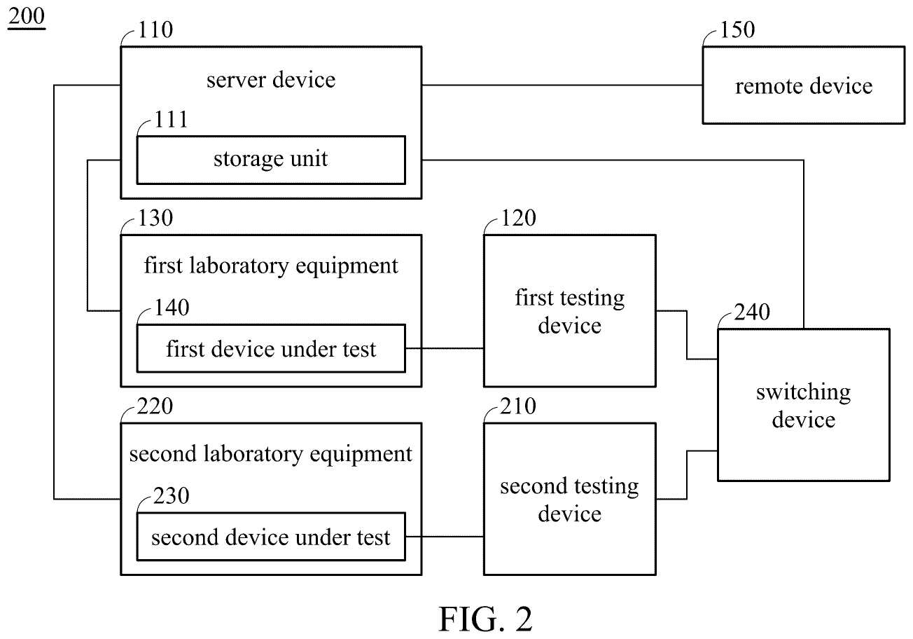

FIG. 2 is a schematic view of an operation of an automated testing system according to another embodiment of the present invention. Please refer to FIG. 2. The automated testing system 200 may include a server device 110, a first testing device 120, first laboratory equipment 130, a remote device, 150 a second testing device 210 and second laboratory equipment 220. In the embodiment, the server device 110, the first testing device 120, the first laboratory equipment 130 and the remote device 150 in FIG. 2 are the same as or similar to the server device 110, the first testing device 120, the first laboratory equipment 130 and the remote device 150 in FIG. 1. Accordingly, the server device 110, the first testing device 120, the first laboratory equipment 130 and the remote device 150 in FIG. 2 may refer to the description of the embodiment of FIG. 1, and the description thereof is not repeated herein.

The second testing device 210 may be connected to the server device 110. In the embodiment, the second testing device 210 may be connected to the server device 110 through the wired network equipment or the wireless network equipment. For example, the wired network equipment may include a wired network switch and a network line, and may perform the data receiving or the data transmission through Ethernet, optical fiber network, asymmetric digital subscriber line, etc. In addition, the wireless network equipment may include a wireless network switch and a wireless network access point, and may use, for example, wireless fidelity technology, or other telecommunication network technologies to perform the data receiving or the data transmission.

The second testing device 210 may set a second testing parameter. That is, the user may operate the second testing device 210 to set the second testing parameter. In the embodiment, the second testing parameter may include a testing parameter required for testing a second device under test 230 and a control parameter of the second laboratory equipment 220.

In addition, the second testing device 210 may also set the second testing parameter through the remote device 150. That is the user may operate the second testing device 210 through the remote device 150 to set the second testing parameter. Therefore, the convenience of use may be increased.

The second testing device 210 may read the laboratory equipment data. That is, the second testing device 210 may access the storage unit 111 of the server device 110 to read the laboratory equipment data stored in the storage unit 111. In some embodiments, the laboratory equipment data may include the related data of the first laboratory equipment 130 and the second laboratory equipment 220, such as the first laboratory equipment 130 and the second laboratory equipment 220 being in a normal state, an abnormal state, etc.

The second testing device 210 may generate a second control command to the server device 110 according to the second testing parameter and the laboratory equipment data. That is, the second testing device 210 may generate the second control command to the server device 110 according to the control parameter of the second laboratory equipment 220 in the second testing parameter and the related data of the second laboratory equipment 220 of the laboratory equipment data.

In some embodiments, the second control command may include a function code, an equipment identifier (equipment ID) and control data, but the embodiment of the present invention is not limited thereto. In addition, the above function code includes, for example, a writing code or a reading code. Furthermore, the above equipment identifier is, for example, an equipment identifier of the second laboratory equipment 220. Moreover, the above control data includes, for example, temperature, humidity, etc.

The second testing device 210 may test the second device under test 230 according to the second testing parameter to generate a second testing result. That is, the second testing device 210 may test the second device under test 230 according to the testing parameter required for testing the second device under test 230 in the second testing parameter to generate the corresponding second testing result. In addition, the second testing device 210 may transmit the second testing result to the server device 110 and store the second testing result in the storage unit 111. Furthermore, the second testing device 210 may also display the second first testing result.

The second laboratory equipment 220 may be connected to the server device 110. In addition, the second device under test 230 may be placed in the second laboratory equipment 220. The second laboratory equipment 220 may be connected to the server device 110 through the wired network equipment or the wireless network equipment. For example, the wired network equipment may include the wired network switch and the network line, and may perform the data receiving or the data transmission through Ethernet, optical fiber network, asymmetric digital subscriber line, etc. In addition, the wireless network equipment may include the wireless network switch and the wireless network access point, and may use, for example, wireless fidelity technology, or other telecommunication network technologies to perform the data receiving or the data transmission.

In addition, the server device 110 may receive the second control command generated by the second testing device 210, and control the operation of the second laboratory equipment 220 according to the second control command. Then, the server device 110 may read the second operating state of the second laboratory equipment 220, and store the second operating state in the storage unit 111. Therefore, it may effectively decrease the error rate of the parameter setting and decrease the testing time and the testing cost.

In some embodiments the second testing device 210 is, for example, an auto test system (ATS) testing station, and the second testing device 210 may include a computer device and at least one testing element. The computer device may be connected to the second device under test 230 and the server device 110. The at least one testing element may be connected to the computer device and the second device under test 230.

In some embodiments, the above at least one testing element may include a chiller and a power supply, but the embodiment of the present invention is not limited thereto. Furthermore, the power supply may include a high voltage power supply or a low voltage power supply. Moreover, the user may select the number of testing elements in the second testing device 210 according to the requirements thereof.

In some embodiments, the second laboratory equipment 220 may include a temperature chamber, a chiller and a recorder. Furthermore, the second device under test 230 may be placed in temperature chamber of the second laboratory equipment 220. In addition, the above recorder may recode the temperature, humidity, etc. In the embodiment, the chiller in the second testing device 210 is different from the chiller in the second laboratory equipment 220. In addition, the second device under test 230 and the first device under test 140 may be the same or different.

In addition, in some embodiments, the remote device 150 may also display the complete data or the partial data of the laboratory equipment data, the first testing result, the first operating state, the second testing result and the second operating state. The above complete data is, for example, the data of the laboratory equipment data, the first testing result, the first operating state, the second testing result and the second operating state during the entire testing process.

The above partial data is, for example, the data of the laboratory equipment data, the first testing result, the first operating state, the second testing result and the second operating state during a certain testing period of the entire testing process. That is, the user may operate the remote device 150, so that the remote device 150 displays the complete data or the partial data. Therefore, the convenience of use may be increased.

In some embodiments the automated testing system 200 may further include a switching device 240. The switching device 240 may be connected among the server device 110, the first testing device 120 and the second testing device 210. That is, the server device 110 may be connected to the first testing device 120 or the second testing device 210 through the switching device 240.

In addition, the server device 110 may use a polling manner to transmit the first control command to the first testing device 120 and the second control command to the second testing device 210, and to read the first operating state of the first laboratory equipment 130 and the second operating state of the second laboratory equipment 220.

In some embodiments, the server device 110 may also perform a calibration process on the second laboratory equipment 220. In addition, the calibration process of the server device 110 for the second laboratory equipment 220 is the same as or similar to that of the server device 110 for the first laboratory equipment 130. Accordingly, the calibration process of the server device 110 for the second laboratory equipment 220 may refer to the description of the embodiment of the calibration process of the server device 110 for the first laboratory equipment 130, and the description thereof is not repeated herein.

In FIG. 2, the automated testing system 200 includes two testing devices (i.e., the first testing device 120 and the second testing device 210) and two pieces of laboratory equipment (i.e., the first laboratory equipment 130 and the second laboratory equipment 220), but the embodiment of the present invention is not limited thereto. In other embodiments, the automated testing system may include three or more testing devices and three or more pieces of laboratory equipment. In addition, the connection manner and the operation thereof of the three or more testing devices and the three or more pieces of laboratory equipment may refer to the description of the embodiment of FIG. 2, and the description thereof is not repeated herein.

In summary, according to the automated testing system disclosed by the embodiment of the present invention, the first testing device sets the first testing parameter, reads the laboratory equipment data the storage unit of the server device, generates the first control command to the server device according to the first testing parameter and the laboratory equipment data, tests the first device under test placed in the first laboratory equipment according to the first testing parameter to generate the first testing result,, and stores the first testing result in the storage unit. In addition, the server device controls the operation of the first laboratory equipment according to the first control command, and the server device reads the first operating state of the first laboratory equipment and stores the first operating state in the storage unit. Therefore, it may effectively decrease the error rate of the parameter setting, decrease the testing time and the testing cost, and increase the convenience of use.

While the present invention has been described by way of example and in terms of the preferred embodiments, it should be understood that the present invention is not limited to the disclosed embodiments. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An automated testing system, comprising:
a server device, comprising a storage unit, wherein the storage unit is configured to store laboratory equipment data;
a first testing device, connected to the server device, wherein the first testing device is configured to set a first testing parameter, read the laboratory equipment data, generate a first control command to the server device according to the first testing parameter and the laboratory equipment data, test a first device under test according to the first testing parameter to generate a first testing result, and store the first testing result in the storage unit; and
first laboratory equipment, connected to the server device, wherein the first device under test is placed in the first laboratory equipment;
wherein the server device is configured to control an operation of the first laboratory equipment according to the first control command, and the server device is configured to read a first operating state of the first laboratory equipment and store the first operating state in the storage unit.

2. The automated testing system as claimed in claim 1, wherein the first testing device comprises a computer device and at least one testing element.

3. The automated testing system as claimed in claim 2, wherein the at least one testing element comprises a chiller and a power supply.

4. The automated testing system as claimed in claim 1, wherein the first laboratory equipment comprises a temperature chamber, a chiller and a recorder.

5. The automated testing system as claimed in claim 1, further comprising:
a remote device, connected to the server device, and configured to read the laboratory equipment data, the first testing result and the first operating state, and display the laboratory equipment data, the first testing result and the first operating state.

6. The automated testing system as claimed in claim 5, wherein the first testing device is further configured to set the first testing parameter through the remote device.

7. The automated testing system as claimed in claim 1, further comprising:
a second first testing device, connected to the server device, wherein the second testing device is configured to set a second testing parameter, read the laboratory equipment data, generate a second control command to the server device according to the second testing parameter and the laboratory equipment data, test a second device under test according to the second testing parameter to generate a second testing result, and store the second testing result in the storage unit; and
second laboratory equipment, connected to the server device, wherein the second device under test is placed in the second laboratory equipment;
wherein the server device is configured to control an operation of the second laboratory equipment according to the second control command, and the server device is configured to read a second operating state of the second laboratory equipment and store the second operating state in the storage unit.

8. The automated testing system as claimed in claim 7, further comprising:
a switching device, connected among the server device, the first testing device and the second testing device.

9. The automated testing system as claimed in claim 1, wherein the server device is further configured to perform a calibration process on the first laboratory equipment.

10. The automated testing system as claimed in claim 1, wherein the first control command comprises a function code, an equipment identifier and control data.
